(19) United States
(12) Patent Application Publication
(10) Pub. No.: US 2004/0193455 A1
(43) Pub. Date: Sep. 30, 2004

(54) Dynamic preloading of insurance product data in insurance policy management system

(75) Inventor: John S. Kellington, Cincinnati, OH (US)

Correspondence Address: WOOD, HERRON & EVANS, LLP, 2700 CAREW TOWER, 441 VINE STREET, CINCINNATI, OH, 45202, US

(73) Assignee: The Ohio Casualty Insurance Company, Hamilton, OH

(21) Appl. No.: 10/401,363

(22) Filed: Mar. 28, 2003

(51) Int. Cl. G06F 17/60; G06F 7/00; G06F 17/00; G06F 17/30

(52) U.S. Cl. 705/4; 707/104.1; 707/3

(57) ABSTRACT

An apparatus, program product and method dynamically preload product information from an external database into the working memory of a policy management system to facilitate efficient, high volume access to the product information during runtime of the policy management system. Typically, the dynamic preloading is performed during the initialization or boot-up of an application server in the policy management system, and the working memory is resident in a computer upon which the application server is also resident such that high speed access to the preloaded product information is available. Moreover, accesses to the external database during post-initialization runtime of the application server are typically avoided, thus eliminating the overhead associated with accessing the external database.

### CROSS-REFERENCE TO RELATED APPLICATIONS

This application is related to U.S. Ser. No. ______, filed on even date herewith by John S. Kellington and entitled “OUT-OF-SEQUENCE ENDORSEMENT PROCESSING IN INSURANCE POLICY MANAGEMENT SYSTEM”, which application is incorporated by reference herein.

### FIELD OF THE INVENTION

The invention relates to insurance policy management and computers, computer software and computer systems utilized therefor, and in particular, to accessing product information stored in an external database in a policy management system.

### BACKGROUND OF THE INVENTION

Insurance policy management systems are among the most complex systems in the information technology industry. A policy management system is typically required to provide the capability for designing unique insurance products (e.g., collision coverage, bodily injury, etc.), as well as to manage the creation of individual policies for customers or policy holders through an issuance process. Created policies must be shipped to customers, and moreover, after issuance and shipping of the policies, functionality must exist for endorsing (changing), cancelling, reinstating, re-issuing, etc. individual policies.

Each policy created in a policy management system is typically custom-built for an individual customer's unique situation. Moreover, at the end of every policy term, e.g., every six months or a year, a renewal policy must be generated that typically incorporates the same coverage, but with different pricing concepts.

The products that may be administered by a policy management system can also vary significantly. Depending upon the particular insurance company involved, the number of potential lines of business, e.g., auto, home, life, general liability, workers compensation, commercial property, inland marine, crime, business, bonds, umbrella, etc., and the various types of coverages that may be offered in those individual lines of businesses, can create a staggering array of policy options. Furthermore, insurance coverage is often subjected to local legislation and rules, necessitating that each state essentially be considered a different market place, with unique insurance products offered in each such state. Furthermore, considering the frequent modifications of coverages and premium costs, each insurance product tends to change on a relatively frequent basis.

Another problematic issue presented by many policy management systems results from the wide variety of users that may be required to access such a system. System administrators, claims adjusters, accountants, and other employees of an insurance company typically require some access to policy data in managing the day-to-day operation of an insurance company. Moreover, insurance agents are required to access the policy management system to serve their customers, including to create new policies or request modifications to existing policies. Some insurance companies employ their own agents; however, others may rely on independent agents that are not employed by the insurance company. The policy management system typically must be capable of handling accesses to customers'policies from all of these entities. Given also that these entities may be widely dispersed from a geographic standpoint, the manner in which these entities can access a policy management system can present significant challenges to IT personnel.

Conventionally, product information for the available insurance product offerings in a policy management system are hard coded into the software for the system. However, by doing so, the ability to alter product offerings and product information associated therewith is severely hampered. As such, a trend has emerged towards utilizing a separate product database that stores the available product offerings for a policy management system. By doing so, the available product offerings and the information associated therewith may be modified simply by altering the product database, whereby alterations to the software for the policy management system are not required.

Offloading product information to an external product database, however, leads to additional problems. When product information is encoded into the software for a policy management system, retrieval of the product information is generally very efficient. In contrast, when the information is offloaded to an external database, the information is generally retrieved by issuing one or more queries to the product database. When a policy management system is utilized by a large number of users, the number of queries that must be issued to an external database may become a substantial bottleneck on system performance.

In addition, the manner in which data is stored in an external product database can significantly affect the runtime performance of a policy management system. Many policy management systems, for example, utilize relational databases that arrange data into tables, with each table having rows representing individual data records, and with columns representing the data fields in each of the records. The use of a relational database tends to normalize the data, but may require additional processing to retrieve desired information.

The fastest access is typically obtained when product offerings are represented in only a few tables, i.e., where each product has a large number of fields defining the various aspects of that product. However, given the enormous number of types of available product offerings that may be supported by a policy management system, utilizing only a few, relatively “wide” (i.e., large number of fields) tables to represent a large number of product offerings typically would create an administrative nightmare, and require substantially more complex database schema to accurately represent all available product offerings.

In contrast, many of the benefits of a relational database are derived from the ability to distribute data among a multitude of tables to enable data to be reused for different types of entities. For example, in a product database, utilizing a larger number of relatively narrow (i.e., low number of fields) tables to represent the product offerings in a policy management system can significantly decrease the amount of storage required to represent all product offerings, as well as to ease the administrative burden in maintaining the wide variety of product offerings in the database. Such an architecture, however, can further increase the processing overhead associated with obtaining product information from the external database.

In fact, it has been found that with some conventional policy management systems, obtaining product information for a particular product offering on demand during runtime of a policy management system may require five or more separate queries to be issued to the database, coupled with significant processing to dynamically “build” a data structure for the product in the system to organize the data returned as a result of these queries. Moreover, when such a system is utilized to support hundreds or thousands of individual users, the volume of requests or queries to the database can become a significant bottleneck on overall system performance.

Therefore, a substantial need exists in the art for a manner of improving the access of product information from an external database utilized in connection with a policy management system.

### SUMMARY OF THE INVENTION

The invention addresses these and other problems associated with the prior art by providing an apparatus, program product and method that dynamically preload product information from an external database into the working memory of a policy management system to facilitate efficient, high volume access to the product information during runtime of the policy management system. Typically, the dynamic preloading is performed during the initialization or boot-up of an application server in the policy management system, and the working memory is resident in a computer upon which the application server is also resident such that high speed access to the preloaded product information is available. Moreover, accesses to the external database during post-initialization runtime of the application server are typically avoided, thus eliminating the overhead associated with accessing the external database.

Therefore, consistent with one aspect of the invention, access is provided to product information for insurance product offerings in a policy management system through retrieval of product information for a plurality of insurance product offerings from an external database, coupled with the dynamic creation of a plurality of product data structures in a working memory in the policy management system using the retrieved product information, with each product data structure associated with an insurance product offering from among the plurality of insurance product offerings. The retrieval of product information and the creation of product data structures occurs during initialization of the policy management system. Furthermore, each product data structure is accessible from the working memory during runtime of the policy management system to facilitate the retrieval of product information for the associated insurance product offering independent of the external database.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a policy management system incorporating dynamic preloading of insurance product data consistent with the invention.

FIG. 2 is a block diagram illustrating an exemplary database schema for the product database referenced in FIG. 1.

FIG. 3 is a flowchart illustrating the program flow of a product instantiation routine executed during initialization of the product component referenced in FIG. 1.

FIG. 4 is a flowchart illustrating the program flow of the assemble roles routine referenced in FIG. 3.

FIG. 5 is a flowchart illustrating the program flow of the assemble products routine referenced in FIG. 3.

FIG. 6 is a flowchart illustrating the program flow of an access product information routine executed by the product component referenced in FIG. 1.

### DETAILED DESCRIPTION

The embodiments discussed hereinafter dynamically preload insurance product information into an insurance policy management system to facilitate efficient, high volume access to the product information in connection with the creation and management of customer insurance policies. Product information is retrieved from an external database such as a product data database, and loaded into a working memory such as a solid state memory having a substantially faster access rate than the external database. Such preloading occurs during initialization of a policy management system such that, during runtime (i.e., subsequent to initialization, and during operational use by end users) the product information may be accessed independent of the external database, e.g., without having to query the database to retrieve the desired information.

In the embodiments discussed below, for example, a policy management system is implemented as a three-tiered architecture, with a web server used to interact with end users, an application server utilized to support the principal policy management operations in the system, and an online transaction processing server used to provide back end services. In the herein-described embodiments, it is the application server that maintains product information for the available insurance product offerings for the policy management system, and as such, it is typically the application server that dynamically preloads the product information from an external database into a working memory that is accessible by the application server. This dynamic preload occurs during initialization or boot-up of the application server, and typically product information for all of the available product offerings, or alternatively, a portion of the available product offerings, is dynamically preloaded into the working memory during this initialization. It will be appreciated, however, that the invention may be utilized in other environments consistent with the invention.

Also, in the herein-described embodiments, the product information stored in the working memory is done so utilizing a plurality of product data structures that are respectively associated with different insurance policy product offerings available in the policy management system. The product data structures can take a number of different forms, and are typically implemented as objects in an object-oriented environment. Furthermore the product information stored in the product data structures that are created in a working memory need not utilize the same data structures when resident in the external database. For example, the product information may be resident in a relational database, and arranged into a plurality of tables. The product information may be retrieved via queries (e.g., SQL queries) issued to the external database, with the results of the queries utilized to build the product data structures in working memory. Given the innumerable number of possible database and object architectures that may be used in connection with the invention, it will be appreciated that the invention is not limited to the particular database and working memory-resident product data structure architectures described herein.

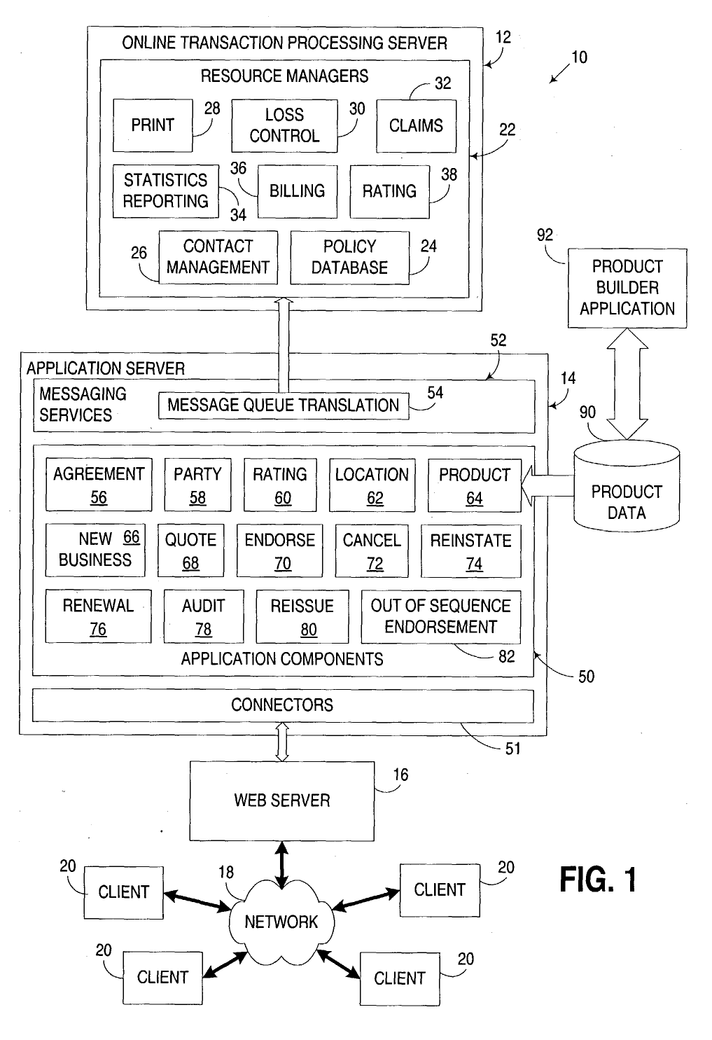

Turning now to the Drawings, wherein like numbers denote like parts throughout the several views, FIG. 1 illustrates an exemplary policy management system 10 incorporating dynamic preloading of product data consistent with the invention. In this implementation, policy management system incorporates a three-tiered structure including an online transaction processing server 12, application server 14 and web server 16 that couples to a network 18 for access thereto by a plurality of clients 20. Each server 12, 14, 16 generically represents, for example, any of a number of different types of multi-user computer systems such as network servers, midrange computers, mainframe computers, etc. Moreover, each server 12, 14, 16 may be implemented using multiple computer systems, e.g., via clustering and other distributed processing techniques. Irrespective of how each server 12, 14, 16 is implemented, however, each such server may individually or collectively be referred to as an “apparatus” hereinafter.

Each server 12, 14, 16 typically includes a central processing unit (CPU) including one or more microprocessors coupled to a memory, which may represent the random access memory (RAM) devices comprising the main storage of the respective server, as well as any supplemental levels of memory, e.g., cache memories, non-volatile or backup memories (e.g., programmable or flash memories), read-only memories, etc. In addition, the memory may be considered to include memory storage physically located elsewhere in the respective server, e.g., any cache memory in a processor, as well as any storage capacity used as a virtual memory, e.g., as stored on a mass storage device or form of external or networked data storage.

Consistent with the herein-described three-tiered architecture, clients 20 access policy management system 10 via web server 16 that is interconnected to the clients via a public network such as the Internet and/or via other forms of networks such as private networks, wired or wireless networks, etc. Clients 20 are typically single-user computers, and are utilized by individual users to access the policy management system. Depending upon the rights granted to particular users, various entities may access a policy management system, including, for example, system administrators, policyholders, insurance company employees, outside agents, etc.

Web server 16 interacts with clients via standard Internet-based protocols such as HTML, Java, etc. to support client access to the policy management system through a standard browser, often eliminating the need to install dedicated software on each client. In other implementations, proprietary installed software may be utilized on the client-side to access a policy management system.

Web server 16 acts as a front-end to the policy management system, and accesses application server 14 to initiate policy management operations and otherwise permit client access to the policy management system. Application server 14 in turn relies upon online transaction processing server 12 to perform back-end and database support. While other online transaction processing server architectures may be used, one suitable architecture for use in a policy management system consistent with the invention is IBM's CICS architecture.

It will be appreciated that the three-tiered architecture described herein is merely exemplary in nature, as other system architectures may be utilized to implement a policy management system consistent with the invention. The invention is therefore not limited to the particular hardware and/or software components described herein.

As will be appreciated by one of ordinary skill in the art, each server 12, 14, 16 operates under the control of an operating system, and executes or otherwise relies upon various computer software applications, components, programs, objects, modules, data structures, etc. to implement the various functions described hereinafter. In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Now turning to the principal software components in policy management system 10, from the standpoint of online transaction processing server 12, a plurality of resource managers 22 are supported, including a policy database manager 24 that manages an insurance policy database that stores relevant information about the various insurance policies being managed by the policy management system. Furthermore, a contact management component 26 manages personnel contacts, i.e., the individuals that may utilize or otherwise be represented in the policy management system, as well as the roles those people play. Additional resource managers may include a print manager 28, a loss control manager 30, a claims manager 32, a statistics reporting manager 34, a billing manager 36 and a rating manager 38. Print manager 28 handles the printout of insurance policies, while loss control manager 30 is utilized to format information for performing surveys. Claims manager 32 handles the claims processing interaction for the policy management system, and statistics reporting manager 34 handles updates to the actuarial statistics and general ledger entries for the enterprise. Billing manager 36 handles billing functionality, while rating manager 38 is utilized in connection with premium calculation.

It will be appreciated that the implementation of the functionality of each of resource managers 24-38 would be apparent to one of ordinary skill in the art having the benefit of the instant disclosure. Moreover, it will be appreciated that other functionality, as well as other combinations of components, may be utilized to implement the online transaction processing or other back-end services provided by server 12. The invention is therefore not limited to the particular implementation illustrated in FIG. 1.

Application server 14 includes a plurality of application components 50, which are accessed by web server 16 via appropriate connectors 51. For example, each application component 50 may be implemented as a JAVA component, with connectors 51 being used to respond to client requests, and format requests for handling by the appropriate processes or domain components. For example, if a client is a Java Applet, a connector may be configured to respond to a Remote Method Invocation (RMI) call and return an RMI call. If a client is an HTML browser, then a connector may be configured to respond to an HTTP post and re-format an RMI call to send to process or domain components. If a client is an agent's management system, then a connector may take the form of a web service.

To access the back-end services provided by server 12, application server 14 also includes a messaging services component 52 including a message queue translation component 54 utilized in issuing transactions for processing by server 12. The access of an online transaction processing server by an application server in this manner is well known to one of ordinary skill in the art having the benefit of the instant disclosure.

Application components 50 provide a number of application services for accessing and otherwise updating policy data stored in the policy management system. As noted above, each component 50 may be implemented using a JAVA component. In the alternative, other programming languages and execution environments may be utilized in application server 14 consistent with the invention.

Among the various application components illustrated in FIG. 1, an agreement component 56 handles updates to policies and coverages, and any other policy information having a legal effect on coverage of an insured. Party component 58 manages people, organizations, and the roles they play. Rating component 60 is utilized in connection with premium calculation, while location component 62 is utilized in connection with defining places, things, and other contact information for locating people.

Product component 64 is utilized to provide product information representing the available coverages and policy options capable of being selected by a customer. As will be discussed in greater detail below, it is during the initialization of product component 64 that product data may be dynamically reloaded into application server 14 to increase the workload capacity of the server.

Components 66-82 provide a number of transaction types representing various operations that may be performed against an insurance policy. New business component 66, for example, is utilized in connection with adding a new policy or product offering. Quote component 68 is utilized in connection with providing quotations to potential customers. Endorse component 70 is utilized to apply endorsements to an existing policy, while cancel component 72 is utilized to cancel a policy. Reinstate component 74 is utilized in connection with reinstating a previously-canceled policy, and renewal component 76 is utilized to renew an existing policy. Audit component 78 is utilized to audit an existing policy, while re-issue component 80 is utilized to re-issue a prior policy.

An additional application component relied upon by application server 14 is an out-of-sequence endorsement component 82, which implements an out-of-sequence endorsement algorithm, e.g., as described in connection with the aforementioned cross-referenced application. Such an out-of-sequence endorsement is handled in policy management system 10, and in particular, utilizing functionality in application components 82 and/or 70, to apply an out-of-sequence endorsement by first effectively “backing out” endorsements applied to the insurance policy having later effective dates than that of an out-of-sequence endorsement. Once the later endorsements are backed out, and effectively undone from the policy, the out-of-sequence endorsement is then applied to the policy. Thereafter, the previously backed out endorsements are re-applied in proper order. The resulting policy data incorporates all endorsements in the proper sequence, and any premium adjustments that would have resulted from the proper application of endorsements, are automatically calculated. Furthermore, all actuarial statistics and general ledger entries are updated in the proper manner to ensure compliance with financial and accounting rules.

The representation of products, policies and other product- and policy-related information, as well as the implementation of the various components illustrated in servers 12, 14, may be realized in a number different models consistent with the invention. One suitable model, for example, is the Insurance Applications Architecture (IAA) available from International Business Machines Corporation. Other database, transaction processing and/or application server architectures may be utilized in other embodiments consistent with the invention.

In the illustrated embodiment, insurance policies are created from a plurality of products resident in a data structure in application server 14, and managed by product component 64. To facilitate the access to such products, a data structure relied upon by product component 64 is dynamically constructed from information in a product data database 90. By doing so, the overhead associated with accessing the product information for such products is substantially reduced, thereby increasing the workload capacity of the application server.

The product information or data stored in database 90 may be selectively updated by a product builder application 92. Application 92 may be resident on one of servers 12 or 14, or may be resident on a separate computer, and may be used to manage the product data database off line.

The product data database includes product data or information that may be used to create a policy. Practically any information that is relevant to a product offering for a policy management system may be stored in database 90. As will be discussed in greater detail below, for example, product information may be organized into products, roles, and attributes, with name/value pairs utilized to represent all or some of these various entities in the product data database. Products, attributes and/or roles may be assembled together to form product offerings. Multiple product offerings may also be used to construct specifications, which are then collected together to form policies that are suitable for issuing to a customer.

In contrast with many conventional policy management system designs, product information is not encoded into the program code for the policy management system. Rather, a product data database is utilized to provide greater flexibility in terms of product offerings. While use of a product data database would normally provide a bottleneck on system performance in enterprise-wide applications where a large number of users may potentially need to access the product data at the same time, using the preloading or caching functionality described herein, suitable performance is nonetheless realized while maintaining a flexible architecture for updating and otherwise modifying product offerings for the policy management system.

The herein-described policy management system, in particular relies on a relational database having a model or schema compatible with the aforementioned Insurance Applications Architecture. Traditionally, relational databases have been designed to minimize redundancies to normalize their models or schemas. The techniques used are to create tables, where columns of the tables represent attributes of data that need to be stored. A comparatively large number of columns is typically used, resulting in different tables being required for different types of insurance product offerings. For example, an auto policy might require columns relating to type and number of covered vehicles, liability limits, etc., while a homeowner's policy might require columns relating to construction type, age of home, etc. Therefore, for each line of business, the data elements are often very different. This makes the development of a policy management system very difficult because each product typically requires very different data elements be collected, stored, and managed.

In the herein-described policy management system, the product database is architected in a much less “flat” format, utilizing the concept of name/value pairs to store what data is needed to be collected, and what are the appropriate allowed values are to control the editing of the data.

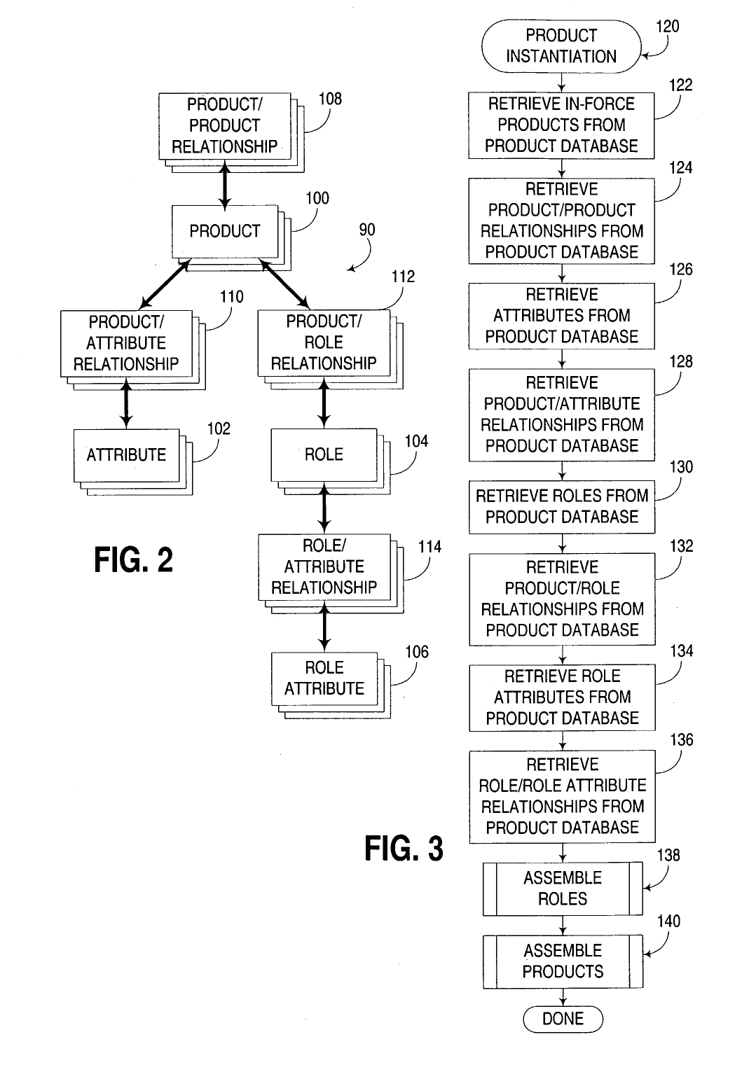

In particular, as shown in FIG. 2, one suitable schema for a product database 90 includes a plurality of products 100, a plurality of attributes 102, a plurality of roles 104, and a plurality of role attributes 106, along with a plurality of relationships, including product/product relationships 108, product/attribute relationships 110, product/role relationships 112 and role/role attribute relationships 114.

Products 100 represent various insurance policy offerings and/or elements of insurance policy offerings, and may be linked together in parent/child relationships to define other products. For example, products may be defined for automobile liability coverage, automobile collision coverage, and automobile liability coverage, and those products maybe related to an overall automobile product that includes all three types of coverages.

Attributes 102 represent name/value pairs that are used describe features of a product, as well as the permissible values for those features. Roles 104 represent people, places or things that can be attached to a product, e.g., names of insureds, addresses, covered properties, etc., while Role attributes 106 represent name/value pairs that are used describe features of a role, as well as the permissible values for those features.

Relationships 108, 110, 112 and 114 are used to associate various entities defined in the schema with one another. Product/product relationships 108, for example, define parent/child relationships between multiple products. Product/attribute relationships 110 define the attributes that are associated with each product, while product/role relationships 112 define the roles that are associated with each product. In the illustrated embodiments, roles themselves may incorporate role attributes (which are conceptually similar to attributes), whereby role/role attribute relationships 114 are used to define those attributes that are associated with each role.

Each set of entities 100-114 may be stored in database 90 in a number of different manners. For example, in the illustrated embodiments, the entities 100-114 are stored in one or more relational tables, the use and configuration of which would be well within the abilities of one of ordinary skill in the art having the benefit of the instant disclosure.

As an extremely simplified example of a relational database schema, consider Tables I-III below, which illustrate one suitable manner of relating attributes to products. Tables I-III are respectively implemented as product, product/attribute relationship and attribute tables for a small subset of product offerings and attributes:

TABLE I
Product Table

| Product No. | Product Name | Effective Date | Expiration Date |
|---|---|---|---|
| 456 | Auto | Sep. 01, 2003 | Null |
| 123 | Home | Oct. 01, 2002 | Null |

TABLE II
Product/Attribute Relationship Table

| Product No. | Attribute No. | Attribute Name |
|---|---|---|
| 456 | 11111 | Liability Limit |
| 456 | 11112 | Number of Cars |
| 123 | 11113 | Construction Type |
| 123 | 11114 | Deductible |

TABLE III
Attribute Table

| Attribute No. | Allowed Value |
|---|---|
| 11111 | $50,000.00 |
| 11111 | $100,000.00 |
| 11112 | 1 |
| 11112 | 2 |
| 11113 | Brick |
| 11113 | Vinyl |
| 11113 | Cedar |
| 11114 | $250.00 |
| 11114 | $500.00 |
| 11114 | $750.00 |

The implementation of role tables, product/role relationship tables, and role/attribute relationship tables in the same manner as described above, would be well within the abilities of one of ordinary skill in the art having the benefit of the instant disclosure. Moreover, it will be appreciated that a wide variety of other schemas may be used to represent product information in a database for a policy management system. Accordingly, the invention is not limited to the particular schema described herein.

It will also be appreciated that, although the table design to support the aforementioned entities is more complex, it provides virtually unlimited flexibility. Using this schema, adding additional lines of business or new coverages typically requires inserting new rows as opposed to adding additional tables or more columns, which ultimately reduces the amount of program code that is needed and the maintenance of such program code. In addition, by supporting the concept of product-related specifications (i.e., sets of allowed values for a given attribute or other entity), programming is substantially simplified, as no hard coding of “edits” in the software are required to make sure only certain values are selected.

Returning briefly to FIG. 1, as noted above, in the herein-described policy management system a product component 64 is used to drive how products and policies are created. In the illustrated embodiment, when the product component initializes (e.g., when the application server is brought up), a product instantiation routine looks at the rows in the tables of the product database 90 and dynamically configures itself by preloading product information into a working memory in the application server. All the data is read at initialization time, rather than when products or policies are created or accessed. This provides an environment that is not only flexible, but also extremely fast, because product data is accessed at memory speed.

FIG. 3 illustrates one potential implementation of a product instantiation routine 120 consistent with the invention. Routine 120 is called during initialization of product component 64, and begins in blocks 122, 124, 126, 128, 130, 132, 134 and 136 by retrieving the product information for all of the products, product/product relationships, attributes, product/attribute relationships, roles, product/role relationships, role attributes and role/role attribute relationships stored in the product database. In the illustrated embodiment, such product information is retrieved via queries issued to the product database, e.g., using “SELECT *” SQL queries directed to each of the respective tables in the database. In other embodiments, only a subset of relevant product information may be retrieved by routine 120, e.g., if only a portion of the available product offerings was to be made available to a particular application server.

Once all of the product information has been retrieved in blocks 122-136, an assemble roles routine 138 is called to assemble the roles in the working memory of the application server. An assemble products routine 140 is then called to assemble the products in the working memory of the application server. Once these entities are assembled, routine 120 is complete.

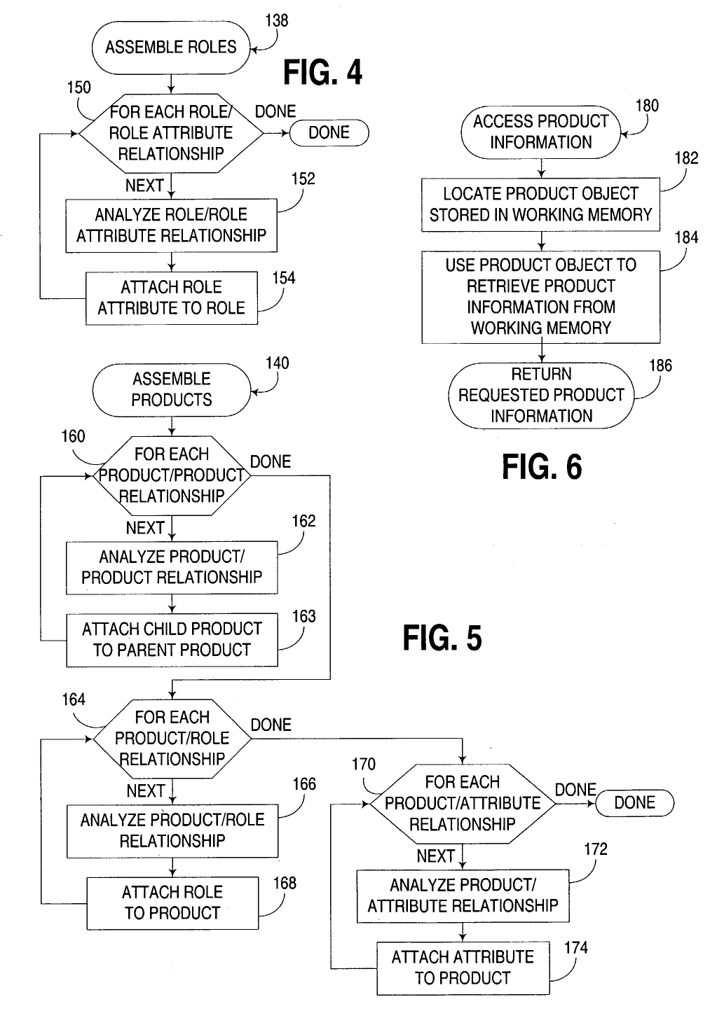

Routine 138 is illustrated in further detail in FIG. 4. The routine begins in block 150 by initiating a loop to process each role/role attribute relationship retrieved in routine 120 (e.g., via a query issued in block 136 of FIG. 3). For each such relationship, control passes to block 152 to analyze the role/role attribute relationship to determine the role and role attribute to be associated together via the relationship. Control then passes to block 154 to attach the determined attribute to the determined role, e.g., by creating objects (or other data structures) for the role attribute and role as they are needed using the product information retrieved from the database, and attaching (or otherwise referencing) the role attribute object to the role object. Control then returns to block 150 to process additional role/role attribute relationships. Once all such relationships have been processed, routine 138 is then complete.

Routine 140 is illustrated in further detail in FIG. 5. The routine begins in block 160 by initiating a loop to process each product/product relationship retrieved in routine 120 (e.g., via a query issued in block 124 of FIG. 3). For each such relationship, control passes to block 162 to analyze the product/product relationship to determine the products to be associated together via the relationship. Control then passes to block 163 to attach the determined child product in the relationship to the determined parent product, e.g., by creating objects (or other data strictures) for the child and parent products as they are needed using the product information retrieved from the database, and attaching (or otherwise referencing) the child product object to the parent product object. Control then returns to block 160 to process additional product/product relationships.

Once all such relationships have been processed, block 160 then passes control to block 164 to initiate a loop to process each product/role relationship retrieved in routine 120 (e.g., via a query issued in block 132 of FIG. 3). For each such relationship, control passes to block 166 to analyze the product/role relationship to determine the product and role to be associated together via the relationship. Control then passes to block 168 to attach the determined role in the relationship to the determined product, e.g., by creating objects (or other data structures) for the product and role as they are needed using the product information retrieved from the database, and attaching (or otherwise referencing) the role object to the product object. Control then returns to block 164 to process additional product/role relationships.

Once all such relationships have been processed, block 164 then passes control to block 170 to initiate a loop to process each product/attribute relationship retrieved in routine 120 (e.g., via a query issued in block 128 of FIG. 3). For each such relationship, control passes to block 172 to analyze the product/attribute relationship to determine the product and attribute to be associated together via the relationship. Control then passes to block 174 to attach the determined attribute in the relationship to the determined product, e.g., by creating objects (or other data structures) for the product and attribute as they are needed using the product information retrieved from the database, and attaching (or otherwise referencing) the attribute object to the product object. Control then returns to block 170 to process additional product/attribute relationships. Once all such relationships have been processed, routine 140 is then complete.

It will be appreciated that creating suitable objects in the working memory, as well as attaching such objects to one another in recursive data structures such as those described herein, are well within the abilities of one of ordinary skill in the art having the benefit of the instant disclosure.

Upon completion of routines 120, 138 and 140, the data structures resident in the working memory of the application server store functionally equivalent product information to that stored in product database 90. While the data structures may differ in architecture between the working memory and the external database, the product information that may be obtained therefrom is essentially equivalent from the perspective of the product component. As such, product information may be accessed during runtime of the application server and policy management system using the data structures in the working memory in lieu of accessing the product database. Substantially faster access is therefore obtained, as is substantially greater workload capacity for the application server.

As an example, FIG. 6 illustrates an access product information routine 180 that may be called by the product component whenever desirable to access product information originally stored in the product database. Routine 180 begins in block 182 by locating the relevant product object for the product information being requested. Block 184 then uses the product object to retrieve the requested product information from working memory, e.g., by traversing through the product object to access any necessary child objects, attributes, roles, role attributes, etc. Block 186 then returns the requested product information, whereby routine 180 is then complete.

It will be appreciated that traversal of an object and/or a chain of objects to obtain information stored therein would be well within the abilities of one of ordinary skill in the art having the benefit of the instant disclosure.

The embodiments discussed herein therefore substantially improve the performance and workload capacity of a policy management system with regard to accessing product information associated with the available insurance product offerings of the system. Moreover, it will be appreciated that updates to the product offerings may be supported through simple modification of the data in the product database, followed by a re-initialization of the product component in the application server (e.g., by rebooting the application server). In the alternative, it may be desirable to support dynamic reconfiguration of the production information in the working memory to avoid the necessity of rebooting an application server.

Other modifications will be apparent to one of ordinary skill in the art having the benefit of the instant disclosure. Therefore, the invention lies in the claims hereinafter appended.

What is claimed is:

1. A computer-implemented method of providing access to product information for insurance product offerings in a policy management system, the method comprising, during initialization of the policy management system:
retrieving product information for a plurality of insurance product offerings from an external database; and
dynamically creating a plurality of product data structures in a working memory in the policy management system using the retrieved product information, wherein each product data structure is associated with an insurance product offering from among the plurality of insurance product offerings, and wherein each product data structure is accessible from the working memory during runtime of the policy management system to facilitate the retrieval of product information for the associated insurance product offering independent of the external database.

2. The method of claim 1, wherein retrieving the product information and dynamically creating the plurality of product data structures are performed for all insurance product offerings for the policy management system prior to completion of the initialization of the insurance policy management system.

3. The method of claim 1, further comprising, after initialization of the policy management system, accessing product information for a selected insurance product offering among the plurality of insurance product offerings by accessing the associated product data structure resident in the working memory.

4. The method of claim 3, wherein each product data structure comprises a product object, wherein accessing product information for the selected insurance product offering comprises accessing the associated product object.

5. The method of claim 3, wherein the policy management system comprises an application server having access to the working memory, wherein retrieving the product information and dynamically creating the plurality of product data structures are performed by the application server during initialization thereof, and wherein accessing the product information is performed by the application server after initialization thereof.

6. The method of claim 1, wherein the product information stored in the external database for the plurality of insurance product offerings includes a product table, an attribute table and a relationship table, the product table defining a plurality of products, the attribute table defining a plurality of attributes, and the relationship table defining a plurality of relationships between products and attributes respectively defined in the product and attribute tables, wherein the plurality of products includes a first product, the plurality of attributes includes a first attribute, and the plurality of relationships includes a first relationship that associates the first attribute with the first product, and wherein dynamically creating the plurality of product data structures in the working memory includes:
assembling a first product data structure for the first product by accessing the first relationship to determine the association of the first attribute with the first product; and
associating the first attribute with the first product data structure in response thereto.

7. The method of claim 6, wherein the relationship table comprises a product/attribute relationship table, wherein each of the plurality of relationships in the product/attribute relationship table defines a product/attribute relationship, wherein the product information stored in the external database for the plurality of insurance product offerings further includes a product/product relationship table that defines a plurality of product/product relationships between child and parent products defined in the product table, wherein the plurality of products further includes a second product, wherein the plurality of product/product relationships includes a first product/product relationship that associates the second product with the first product in a child/parent relationship, and wherein dynamically creating the plurality of product data structures in the working memory further includes:
accessing the first product/product relationship to determine the association of the second product with the first product; and
associating the second product with the first product data structure in response thereto.

8. The method of claim 6, wherein the relationship table comprises a product/attribute relationship table, wherein each of the plurality of relationships in the product/attribute relationship table defines a product/attribute relationship, wherein the product information stored in the external database for the plurality of insurance product offerings further includes a role table, a product/role relationship table, and a role/attribute relationship table, the role table defining a plurality of roles, the product/role relationship table defining a plurality of product/role relationships between products and roles respectively defined in the product and roles tables, the role/attribute relationship table defining a plurality of role/attribute relationships between roles and attributes respectively defined in the roles and attributes tables, wherein the plurality of roles includes a first role, the plurality of attributes includes a second attribute, the plurality of product/role relationships includes a first product/role relationship that associates the first role with the first product, and the plurality of role/attribute relationships includes a first role/attribute relationship that associates the second attribute with the first role, and wherein dynamically creating the plurality of product data structures in the working memory further includes:
accessing the first role/attribute relationship to determine the association of the second attribute with the first role and associating the second attribute with the first role in response thereto; and
accessing the first product/role relationship to determine the association of the first role with the first product and associating the first role with the first product in response thereto.

9. The method of claim 6, wherein each attribute defined in the attribute table includes a name/value pair.

10. The method of claim 6, wherein retrieving the product information for the plurality of insurance product offerings from the external database includes retrieving all of the product information from the product, attribute, and relationship tables via queries to the external database.

11. The method of claim 1, wherein the external database comprises a relational database.

12. A policy management system, comprising:
a working memory;
at least one processor; and
program code executable by the processor during initialization of the policy management system and configured to retrieve product information for a plurality of insurance product offerings from an external database, and to dynamically create a plurality of product data structures in the working memory using the retrieved product information, wherein each product data structure is associated with an insurance product offering from among the plurality of insurance product offerings, and wherein each product data structure is accessible from the working memory during runtime of the policy management system to facilitate the retrieval of product information for the associated insurance product offering independent of the external database.

13. The policy management system of claim 12, wherein the program code is configured to retrieve the product information and dynamically create the plurality of product data structures for all insurance product offerings for the policy management system prior to completion of the initialization of the insurance policy management system.

14. The policy management system of claim 12, wherein the program code is further configured to, after initialization of the policy management system, access product information for a selected insurance product offering among the plurality of insurance product offerings by accessing the associated product data structure resident in the working memory.

15. The policy management system of claim 14, wherein each product data structure comprises a product object, wherein the program code is configured to access product information for the selected insurance product offering by accessing the associated product object.

16. The policy management system of claim 14, wherein the program code is disposed in an application server having access to the working memory, wherein the program code is configured to retrieve the product information and dynamically create the plurality of product data structures during initialization of the application server, and wherein the program code is configured to access the product information after initialization of the application server.

17. The policy management system of claim 12, wherein the product information stored in the external database for the plurality of insurance product offerings includes a product table, an attribute table and a relationship table, the product table defining a plurality of products, the attribute table defining a plurality of attributes, and the relationship table defining a plurality of relationships between products and attributes respectively defined in the product and attribute tables, wherein the plurality of products includes a first product, the plurality of attributes include's a first attribute, and the plurality of relationships includes a first relationship that associates the first attribute with the first product, and wherein the program code is configured to dynamically create the plurality of product data structures in the working memory by assembling a first product data structure for the first product by accessing the first relationship to determine the association of the first attribute with the first product, and associating the first attribute with the first product data structure in response thereto.

18. The policy management system of claim 17, wherein the relationship table comprises a product/attribute relationship table, wherein each of the plurality of relationships in the product/attribute relationship table defines a product/attribute relationship, wherein the product information stored in the external database for the plurality of insurance product offerings further includes a product/product relationship table that defines a plurality of product/product relationships between child and parent products defined in the product table, wherein the plurality of products further includes a second product, wherein the plurality of product/product relationships includes a first product/product relationship that associates the second product with the first product in a child/parent relationship, and wherein the program code is configured to dynamically create the plurality of product data structures in the working memory further by accessing the first product/product relationship to determine the association of the second product with the first product, and associating the second product with the first product data structure in response thereto.

19. The policy management system of claim 17, wherein the relationship table comprises a product/attribute relationship table, wherein each of the plurality of relationships in the product/attribute relationship table defines a product/attribute relationship, wherein the product information stored in the external database for the plurality of insurance product offerings further includes a role table, a product/role relationship table, and a role/attribute relationship table, the role table defining a plurality of roles, the product/role relationship table defining a plurality of product/role relationships between products and roles respectively defined in the product and roles tables, the role/attribute relationship table defining a plurality of role/attribute relationships between roles and attributes respectively defined in the roles and attributes tables, wherein the plurality of roles includes a first role, the plurality of attributes includes a second attribute, the plurality of product/role relationships includes a first product/role relationship that associates the first role with the first product, and the plurality of role/attribute relationships includes a first role/attribute relationship that associates the second attribute with the first role, and wherein the program code is configured to dynamically create the plurality of product data structures in the working memory further by accessing the first role/attribute relationship to determine the association of the second attribute with the first role and associating the second attribute with the first role in response thereto, and accessing the first product/role relationship to determine the association of the first role with the first product and associating the first role with the first product in response thereto.

20. The policy management system of claim 17, wherein each attribute defined in the attribute table includes a name/value pair.

21. The policy management system of claim 17, wherein the program code is configured to retrieve the product information for the plurality of insurance product offerings from the external database by retrieving all of the product information from the product, attribute, and relationship tables via queries to the external database.

22. The policy management system of claim 12, wherein the external database comprises a relational database.

23. A program product, comprising:
program code configured to execute during initialization of a policy management system by retrieving product information for a plurality of insurance product offerings from an external database, and dynamically creating a plurality of product data structures in a working memory in the policy management system using the retrieved product information, wherein each product data structure is associated with an insurance product offering from among the plurality of insurance product offerings, and wherein each product data structure is accessible from the working memory during runtime of the policy management system to facilitate the retrieval of product information for the associated insurance product offering independent of the external database; and
a signal bearing medium bearing the program code.

24. The program product of claim 23, wherein the signal bearing medium includes at least one of a transmission medium and a recordable medium.
